(19) United States
(12) Patent Application Publication
(10) Pub. No.: US 2011/0264931 A1
(43) Pub. Date: Oct. 27, 2011

(54) POWER CONTROL SYSTEM FOR WORKSTATIONS

(75) Inventors: Sophie Chang, London (GB); Mark Blackburn, Berkshire (GB)

(73) Assignee: 1E Limited, a British company of CP House, London (GB)

(21) Appl. No.: 13/003,180

(22) PCT Filed: Jul. 10, 2009
(86) PCT No.: PCT/GB2009/001723

§ 371 Date: Jul. 8, 2011

(30) Foreign Application Priority Data
Jul. 10, 2008 (GB) 0812673.2

(51) Int. Cl. G06F 1/32

(52) U.S. Cl. 713/310

(57) ABSTRACT

A power control system for workstations (31-54) which are connected to a network (2). An application (300) running on a server (1) has access to a profile database (304) which stores records of estimated workstation start and end times and estimated user start and end times, and sends shut down and start up instructions to each workstation in accordance with the profile data. The time assumed to be the working day start for a workstation is either the estimated working day start for that workstation, or the estimated working day start for the user most likely to use that workstation. The time assumed to be the working day end for a workstation is either the estimated working day end for that workstation, or the estimated working day end for a user on that workstation. Workstation and user data is logged (303) to create the profiles.

The present invention relates to a power control system for data processing workstations that are attached to a network, such as personal computers, thin client terminals, laptop computers, and so forth.

It is known to reduce the energy consumption of data processing equipment by ensuring that the equipment changes from a higher energy usage state to a lower power usage state when possible. For example, a personal computer or a laptop may have a fully on state, a fully off state and one or more intermediate “sleep” states, including for example the display going off, the processor operating at reduced speed, and full hibernation. In some cases these states are instigated automatically, when there has been a predetermined period of inactivity, and additionally or alternatively they may be instigated manually, for example by a user opting to turn a machine off.

Embodiments of the present invention are particularly concerned with changing the state of a data processing workstation between a fully on and a fully off condition, although the invention is also applicable to entering or leaving intermediate sleep states.

1E Limited of London, United Kingdom, markets two products named NightWatchman™ and 1E WakeUp™. These can be used with networked workstations to control on and off states remotely. A server running the programs can use NightWatchman to turn all workstations off at a predetermined time of day, for example at 20:00. During the night, if a software patch has to be downloaded to the workstations, they are woken up by 1E WakeUp and when the patch has been downloaded they are all turned off again. 1E Wake Up can also ensure that all workstations are switched on in the morning, say at 07:00, so that they are ready for use by operatives when their working days start. When somebody starts work in the morning their workstation will have been turned on and typically it will be in one of the intermediate sleep states, depending on how long after turning on the person arrives, from which it will become operational in a relatively short length of time.

Such an arrangement ensures that computers are not left on all night, and also enables computers to be in a state of readiness when people arrive for work.

The present invention provides an improvement over such a system.

Viewed broadly from one aspect the present invention can be expressed as providing a power control method for a plurality of data processing workstations which are connected to a network, in which an application running on a server connected to the network is configured to send instructions to the workstations to cause the workstations to enter a relatively low energy usage state from a relatively high energy usage state at a time assumed to be after the end of a working day for the workstations, characterised in that the application has access to a profile database which stores for each particular workstation and/or for each user of a workstation, data representative of an estimated working day end time for that workstation or user, and the application sends a power down instruction to each workstation to cause the workstation to enter the relatively low energy usage state at the estimated working day end time for that particular workstation or user.

This aspect of the present invention can also be expressed as providing data processing apparatus connected to a network on which there is a plurality of data processing workstations, the apparatus comprising a server which is configured to run an application which sends instructions to the workstations to cause the workstations to enter a relatively low energy usage state from a relatively high energy usage state at a time assumed to be after the end of a working day for the workstations, characterised in that the application has access to a profile database which stores for each particular workstation and/or for each user of a workstation, data representative of an estimated working day end time for that workstation or user, and the application sends a power down instruction to each workstation to cause the workstation to enter the relatively low energy usage state at the estimated working day end time for that particular workstation or user.

This aspect of the invention also extends to a data processing system comprising such apparatus and a plurality of the workstations, connected by a network.

This aspect of the invention also extends to a computer program product containing instructions which, when executed on data processing apparatus will cause the apparatus to be configured as set out above.

One embodiment of the present invention provides an arrangement in which the application has access to a profile database which stores for each particular workstation, data representative of an estimated working day end time for that workstation, and the application sends an instruction to each workstation to cause the workstation to enter the relatively low energy usage state at the estimated working day end time for that particular workstation.

In accordance with this embodiment of the invention, instead of all workstations entering a low energy usage state, such as being turned off, at the same time, there are individual times for each workstation which can take into account the location of the workstation, the type of work carried out using the workstation, the working habits of the person or persons using the workstation, and so forth.

The above embodiment of the invention will increase the chance of a particular workstation being taken to an appropriate low energy state, such as completely off, without user intervention at the end of the working day on that particular workstation. There is created and stored a usage profile for each workstation.

However, a further embodiment of the invention takes into account the working pattern of a particular user. This will account for workstations being used by a number of different people. In this case the aim is to create and store a usage profile for each person in the organisation. When that person logs into a workstation, the user profile of the person is relied upon to set the expected working day end for that user.

Thus, another embodiment of the present invention provides an arrangement in which the application has access to a profile database which stores for of a plurality of workstation users, data representative of an estimated working day end time for that workstation user, and the application sends an instruction to each workstation to cause the workstation to enter the relatively low energy usage state at the estimated working day end time for the user of that particular workstation.

In a preferred implementation of user profiles, the stored data can be associated with a selection of different workstations, or types of workstations, or locations. For example, a particular user who works in different offices could have different working patterns for each office. There could be a different working pattern if the user works from home. There could be a different pattern again if the user has a laptop and connects to the office when on a business trip, for example in a different country. Within a particular office, a user might have a different profile when working on one particular workstation where particular tasks are carried out, and a different profile on another workstation. In a research facility, for example, a user might use a workstation in a laboratory for a certain part of the working day, and a workstation in an office for another part of the working day.

In some embodiments there could be data stored for both user and workstation profiles. Thus, if a user logs into a particular workstation and does not yet have a user profile, the system could default to using the workstation profile.

User and workstation data can be combined in a single database. Recording the work end time, or assumed end time, the user concerned, and the workstation concerned, will result in a store of data that can be queried to establish whatever profile is desired. Storing also the location of the workstation when it connects to the system will enable location specific profiles.

A suitable database will enable an appropriate work end time to be calculated in complex and changing circumstances, for example for a laptop that could be used in the office, at home or elsewhere in various countries, and by a number of different users. Depending on all of these factors, an appropriate work end time can be established once a user starts work.

Thus, in a preferred embodiment the invention , the arrangement is such that the application has access to a profile database which stores records of data representative of the identity of a user logged in, the identity of the workstation on which that user is logged in, and the time or assumed time at which the user ceases work on the workstation at the end of a working day, the stored data being used to create a profile for a user indicating an expected end of the working day for that user and/or a profile for a workstation indicating an expected end of the working day for that workstation.

The stored data may include the date when a record is created, and/or the location of the workstation when the record is created.

The above embodiments of the invention provide an improved way of ensuring that workstations are turned off, or their energy requirements reduced significantly, at the end of a working day, taking into account actual working patterns. Another embodiment of the invention concerns turning on of a workstation in sufficient time to be ready for use at the start of the working day. As noted earlier, the 1E WakeUp™ system can be used to turn on all workstations at a particular time of day. As users tend to arrive at work at different times, some workstations will be turned on at an unnecessarily early time, or some could be turned on too late.

In some embodiments of the present invention, the application is also configured to send instructions to the workstations to cause the workstations to change from a low energy usage state to a higher energy usage state at a time assumed to be at the start of a working day for the workstations, in which the application has access to a profile database which stores for each particular workstation, data representative of an estimated working day start time for that workstation, and the application sends an instruction to each workstation to cause the workstation to enter the higher energy usage state at the working day start time for that particular workstation.

Thus, instead of all workstations entering a higher energy usage state (such as being turned on) at the same time, there are individual start times for each workstation which can take into account the location of the workstation, the type of work carried out using the workstation, the working habits of the person or persons using the workstation, and so forth.

This embodiment of the invention will increase the chance of a particular workstation being taken to a higher energy usage state, such as on, without user intervention at the start of the working day on that particular workstation. There is created and stored a usage profile for each workstation.

This embodiment accounts for both the start and end of the working day for a particular workstation, the end of the working day being determined using any of the methods described earlier. Thus, in this embodiment of the invention, the application has access to a profile database which stores for each particular workstation, data representative of an estimated working day start time for that workstation, and data representative of an estimated working day end time for that workstation, and the application sends an instruction to each workstation to cause the workstation to enter the higher energy usage state at the working day start time for that particular workstation, and sends an instruction to each workstation to cause the workstation to enter the lower energy usage state at the working day end time for that particular workstation.

Some embodiments of the invention take into account the working pattern of a particular user to determine an estimated working day start time. This will account for workstations being used by a number of different people. In this case the aim is to create and store a usage profile for each person in the organisation, which can be used to set the expected working day start for that user. Additionally, there is information stored that will be used to determine the user most likely to be working on a particular workstation when it is turned on. Thus, for a particular day of the week, the system can determine who is most likely to be using a particular workstation, and from that person's profile can determine the most likely working day start time.

Thus, in some embodiments of the present invention the application has access to a profile database which stores for each of a plurality of workstation users, data representative of an estimated working day start time for that workstation user, and which stores for each of the plurality of workstations data representative of the user most likely to be using that workstation, and the application sends an instruction to each workstation to cause the workstation to enter a higher energy usage state at the estimated working day start time for the user most likely to be using that particular workstation.

In some preferred arrangements, the system can deal with both workstation and user profiles to determine expected working day start time and expected working day end times.

Thus, in some embodiments the application has access to a profile database which stores for each of a plurality of workstation users, data representative of an estimated working day start time and an estimated working day end time for that workstation user, and which stores for each of the plurality of workstations data representative of the user most likely to be using that workstation; the application sends an instruction to a particular workstation to cause the workstation to enter a higher energy usage state at the estimated working day start time for the user most likely to be using that particular workstation; and when a user has logged in to the particular workstation the application sends an instruction to the workstation to cause the workstation to enter a lower energy usage state at the estimated working day end time for the user.

Thus, the system predicts which user will be using a workstation to turn the workstation on in preparation for the working day, and uses the identity of the actual user who logs on to the workstation to predict the end of the working day when the workstation will be switched off.

A variation of this embodiment of the invention is to use a workstation based start time, and a user based end time. In such an arrangement the application has access to a profile database which stores for each of the plurality of workstations data representative of an estimated working day start for that workstation, and which stores for each of a plurality of workstation users, data representative of an estimated working day end time for that workstation user; the application sends an instruction to a particular workstation to cause the workstation to enter a higher energy usage state at the estimated working day start time for the workstation; and when a user has logged in to the particular workstation the application sends an instruction to the workstation to cause the workstation to enter a lower energy usage state at the estimated working day end time for the user.

In one embodiment of the invention the application has access to at least one profile database which stores records of data representative of the identity of a user logged in, the identity of the workstation on which that user is logged in, the time at which the user logged in to the workstation, and the time or assumed time at which the user ceases work on the workstation at the end of a working day, the records of data being used to provide in respect of a particular workstation, data indicating the user most likely to use that workstation, and/or an estimated working day start for that workstation and/or an estimated working day end for that workstation; the records of data further being used to provide in respect of a particular user, data indicating an estimated working day start for that user and/or an estimated working day end for that user; whereby: the time assumed to be the working day start for a workstation is either the estimated working day start for that workstation, or the estimated working day start for the user most likely to use that workstation; and the time assumed to be the working day end for a workstation is either the estimated working day end for that workstation, or the estimated working day end for a user on that workstation.

To determine and store the working day start time and/or the working day end time for a particular workstation, there could be stored data indicating when the workstation starts and/or stops being used, on a daily basis. This could be during a specific learning period of, for example, a few weeks. Preferably, however, the data is stored on a daily basis continuously so that changes in use patterns can be taken into account, for example if the user changes or if a user has different patterns of working at different times of the year. In any event, the most likely working day start time and/or working day end time can be determined from the stored workstation data, using any appropriate statistical technique.

The stored data could also include information about where the workstation is. For example, a laptop could be used in the office where there will be one profile, at home where there will be another, and on a business trip where there will be another one again. Storing data representing location will enable location related profiles to be built up, and to be implemented depending on the location of the workstation when a user starts work.

The working day start time and/or the working day end time can be assessed for different days of the week, so that the working pattern of a part time user or a user who tends to start work earlier and/or end work later on a particular day of the week, for example, can be accounted for. After an extended period of assessment, it would be possible to have different patterns for different times of the year. Where data is stored continuously, changes in working patterns, such as seasonal variations, can be accounted for although there will normally be a delay before a change is fully accounted for, as the system preferably analyses the data over a period and does not immediately make a full change to the predicted working day start or end simply on the basis of a change on one day.

Thus, if the system has stored a working day end of 18:45 for a particular workstation or user, and a user stops using the workstation at 18:30 on a particular day, the system will not assume that to be a revised working day end to be used for subsequent days. The arrangement may be such that there must be a variation from the working day end for a minimum number of days before it is assumed that the pattern may be changing. This could be a number of consecutive days and/or, if daily patterns are being tracked, a number of weeks in which there has been a change in working pattern on the same day of the week. The same applies to a change from a regular working day start from 08:00 to 08:15, for example.

The arrangement may be such that when a change is detected, there is a gradual move towards the change. For example, using the times given above for the working day end, on the first subsequent day the time might be altered to 18:40. If on the following day there is a change back to 18:45 by the user, the time would be reset to 18:45. On the other hand, if the user still stops work at 18:30, the time would be shifted to 18:35. If the same happens the day after, the time will finally be adjusted to 18:30. There would be a similar progression for a change in the working day start, for example going through 08:05 and 08:10 before finally changing to 08:15.

Determining when a user stops working can be achieved by the server receiving a notification that the user has logged out, either directly from the workstation or from another server in the network which has details as to which workstations are logged in. Additionally or alternatively, the user may be assumed to have stopped working when there is a predetermined period of inactivity on the workstation. This could be a time dependent feature, so that the predetermined period of inactivity varies with the time of day. For example, during the normal working day the period could be a relatively long period, such as a hour, to account for people having meetings, lunch breaks and so forth. Towards the end of the normal working day, it may be assumed that the user has finished work for the day if there is a shorter predetermined period of inactivity, such as half an hour or even shorter. After a particular time of day, the predetermined period could grow progressively shorter, until a minimum chosen not to interfere with the type of short term absences from a workstation that are to be expected in an office.

As a starting point for setting up a usage profile, a user logged on to a particular workstation could be prompted to enter an expected normal end time. This would be used, deviations from it logged, changes to the end time made, and eventually an accurate profile stored. Alternatively, that actual time when a user stops work on the first day that the system is used, could be taken as the starting point—although the user is better placed to know whether that first day is likely to be a typical day.

The system could also utilise human resources or administration data. Data establishing the normal working hours of a user could be used to set up initial records for the estimated working day start and end times for a user, which will then be adjusted as actual start and end times are recorded. Data concerning holidays and sickness can be used to inhibit the turning on of a workstation if it is known that a user will be away, to initiate turning on later than normal if it known that the user will be away in the morning, to initiate turning off earlier than normal if it known that the user will be away in the afternoon, and so forth.

As regards turning a workstation on at the start of the working day, in some embodiments once that is done the system monitors whether a user actually starts work on the workstation within a predetermined period. If not, the system assumes that the user will not be working on that day, and will turn the workstation off. This event will be stored in respect of the workstation and/or the expected user for the workstation. If this happens for a specified number of working days in succession, such as two or three, the system may assume that the expected user for the workstation is away sick or on holiday. The system may then record that the user is to be assumed absent for a predetermined period and that the workstation is not to be turned on until after that period. The predetermined period may for example be until the end of the working week, or a fixed period of working days. If there is more than one user associated with a workstation, turning on for the other user at the standard time will not be affected.

In terms of data handling, there may be a database table which logs events, such as a user logging on or off. Routines will then be carried out at intervals, say on a daily basis, to analyse the data and to generate for each user and/or workstation estimated working day start and/or end times. There will then be a table whose records identify a workstation and an expected start time and/or end time, and optionally a most likely user. Additionally or alternatively there can be a table whose records identify a user and an expected start time and/or end time for that user. There can be a link table which identifies a workstation and a user, and gives an expected start time and/or end time for that combination. Other link tables can deal with location and so forth.

It will be appreciated that whilst the invention is particularly applicable to the handling of a number of workstations on a network, with data stored on a server and a server based application controlling on and off times, there are aspects concerning turning a machine off which could be modified so that the application could run locally on a machine and events be logged locally.

The invention extends to data processing systems configured to carry out the processes involved in implementing the invention, to software products used to configure components of data processing systems to carry out the invention—whether supplied on physical media such as DVD's or supplied as a download—and to methods of using data processing systems to implement the invention.

Where the expression “database” is used, the functions could be carried out by a plurality of databases, or by a single database with appropriate tables. In particular data in respect of logging of events could be stored in one database, and profile data—calculated from analysing the logged event data—could be stored in another database. Where the expression “server is used, the functions could be carried out by a single physical or virtual server, or by a plurality of physical or virtual servers.

An embodiment of the invention will now be described by way of example and with reference to the accompanying drawings in which:

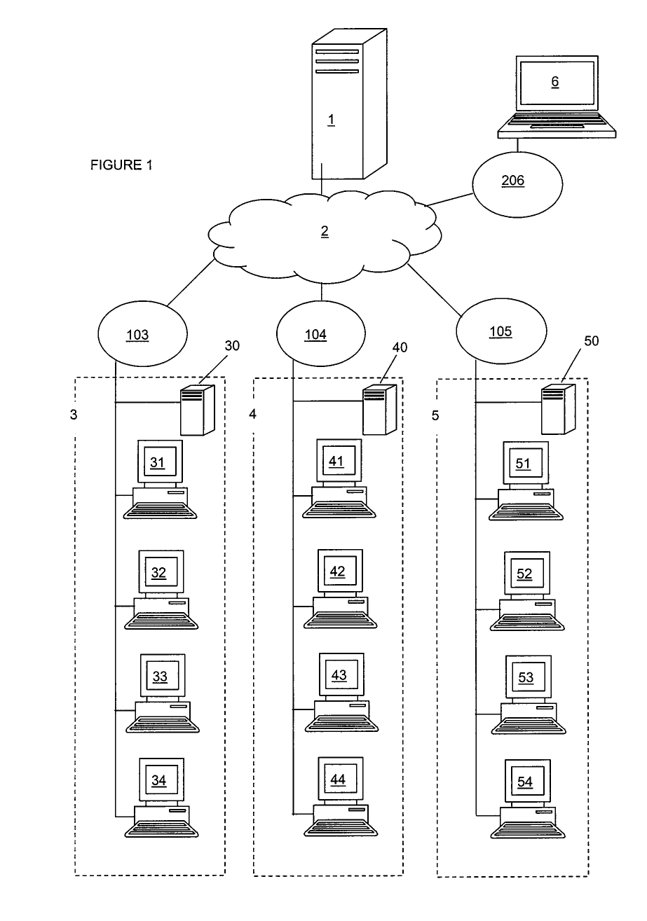

FIG. 1 shows in diagrammatic form a data processing system to which the invention is applied; and

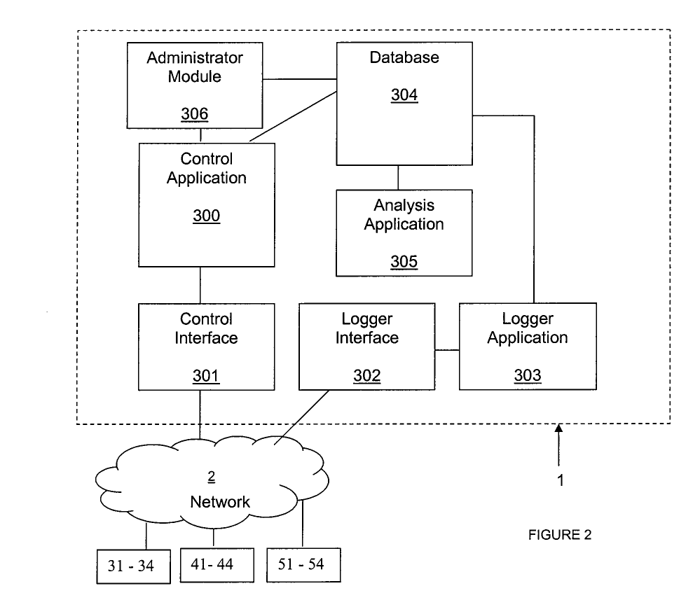

FIG. 2 shows the arrangement of the software components for putting the invention into effect.

FIG. 1 shows an energy usage control server 1 connected to a wide area network 2 so as to communicate with a number of remote sites 3, 4 and 5, respectively having a local server 30, 40 and 50, and number of local client computers 31, 32, 33 34; 41, 42, 43, 44; and 51, 52, 53, 54, via routers 103, 104, and 105. There is also shown a mobile laptop computer 6 which connects to the WAN using an Internet connection 206 over ADSL, for example. The local servers 30, 40, and 50 handle such functions as logging on and logging off of the computers at sites 3, 4 and 5, and can also log events such as a computer going into a sleep mode due to inactivity.

Each of the client computers and the laptop has a Wake-On-LAN enabled network adapter and motherboard. When the computer is powered down, a charge remains on the motherboard which is enough to power the network adapter. If a suitable packet is received by the network adapter, an instruction is provided to power on the computer.

As shown in FIG. 2, the server 1 hosts a control application 300 which connects to the WAN 2 by means of a control interface 301, so that the control application can send instructions to individual ones of the client computers 31 to 34, 41 to 44, 51 to 54 and 6, to power them up or power them down. Also connected to the WAN is a logger interface 302 which receives event data from the local servers 30, 40, and 50, and from the laptop computer. The event data typically comprises the action of a user logging in to or logging of a computer. The logger interface passes events to a logger application which stores appropriate event data in a database 304.

An analysis application 305 is connected to the database 304, and analyses the logged event data, to determine typical logging on and logging off times for users and machines, which are stored in the database 304. That stored data is accessed by the control application, 300 and used to turn computers on and off at appropriate times. The database 304 includes the following tables:

Users

User ID
User Name
User Default Location ID
User Default Machine ID
User Default Start Time
User Default End Time

Locations

Location ID
Location Name
Location Default Start Time
Location Default End Time

Machines

Machine ID
Machine Name
Machine Default Location ID
Machine Default Start Time
Machine Default End Time

User_Machine_Location_Time

User ID
Machine ID
Location ID
Start Time
End Time

Machine_Expected_User

Machine ID
User ID
Start Time
Valid Start Date Time
Valid End Date Time

Machine_Next_Times

Machine ID
Next Start Time
Next Stop Time

Exceptions

User ID
Machine ID
Location ID
Exception Start Date Time
Exception End Date Time
Start Time
End Time

Events

Event ID
Event Time
Event Date
User ID
Machine ID
Location ID
Event Type

Each time that a user logs into a machine or logs out of a machine (or is deemed to be logged out through inactivity) an event is notified to the logger interface 302 by the local servers 30, 40 and 50, or by the laptop 6 itself. The logger application 303 then makes an entry is made in the Events table. This provides a body of data that is queried and analysed by the analysis application to generate data indicative of a default start time and end time for a user, and a default start time and end time for a machine. This is done on a daily basis. More recent data is given greater weight than older data. These default start times and end times are entered into the Users and Machines tables.

The data is also analysed to show links between a user and a machine. For each machine which a user has logged into, the appropriate start time and end time are determined and an entry is made in the User_Machine_Location_Time table. If the same machine has been used at more than one location, there will be more than one entry, with the appropriate locations identified also.

For each machine, an analysis is made of the users that have logged into that machine, in order to determine those who meet criteria to be considered as regular users. The most common user of the machine is recorded in the Machine_Expected_User table. If there is another regular user and it is possible to determine a time/day of the week when that user will normally be the user, a second entry can be made in the table, but with the start and end times in a week when this is valid.

If there are exceptions to the established pattern, for example because a user is going on holiday an entry is made in the Exceptions table. This can be done by an administrator module 306, for example. The period for which the exception is valid is entered, and adjusted start or end times are given. If the user is going on holiday, the start and end times will be set as the same, and this will be interpreted as meaning that there is to be no start time during that period.

The control application running on the server 1 has access to the tables of data, which are updated on a daily basis or more regularly with administrator intervention—for example if somebody is unexpectedly absent through sickness.

At a suitable time before the earliest expected start to a working day, for example at 04:00, the application goes through the machines in sequence. For each machine the application looks firstly in the Machine_Expected_User table for an entry. If there is a single record, that is taken as identifying the expected user. If there is more than one record, the period of validity is inspected to determine whether is covers the start of the following day. If it does, that becomes the expected user.

Having identified the expected user, a check is made in the Exceptions table to determine whether there is an entry for that user which is valid for the following morning. If there is, but there are entries in the machine or location fields which do not correspond to those of the machine being considered, the entry in the table is ignored. Otherwise, if the entry contains a value for the start time, that is taken as the start time of the expected user.

The Exceptions table is also checked for any entries concerning the machine or location which are relevant. An entry in the Exceptions table which is valid for the morning in question and sets a start time, will override any user based start time.

If there are no appropriate entry in the Exceptions table which set a start time, the control application queries the User_Machine_Location_Time table. If there is an appropriate entry linking the expected user with the machine, or at least the machine's location, and that has a start time, then that is taken as the start time. If there is no entry in the User_Machine_Location_Time table, then the application looks at the Users table for the default start time.

If for some reason there is no default start time in the Users table, for example because the user is new, then the application takes the default start time for the machine from the Machines table. If there is not default start time for that, then the application takes the default start time for the machine's location, from the Locations table.

Similarly, if there is no expected user for a machine, then the application takes the default start time for the machine, and if there is no default start time for the machine, then the application takes the default start time for the machine's location.

At the end of this analysis, the control application will normally have determined an appropriate start time for the machine on that morning. The start time is stored in the Machine_Next_Times table in the database 304. If there is to be no start time for a machine on a particular day, for example because there is an exception establishing that the normal user is on holiday, the next start time for the user is set as null. This table is accessed at suitable intervals and when there is a start time imminent for a machine, the control application sends an instruction to the machine to turn on.

After the machine has been turned on, the application waits for a user to log in. When this happens, an event will be recorded in the Events table, for future analysis. The application subsequently conducts an analysis to determine an appropriate time to switch the machine off at the end of the working day. This can be done at any time during the day, and could for example be done when the initial load of dealing with people logging in has passed.

Firstly, the application checks in the Exceptions table to determine whether there is an entry for the user which is valid for that day. If there is, but there are entries in the machine or location fields which do not correspond to those of the machine being considered, the entry in the table is ignored. Otherwise, if the entry contains a value for the end time, that is taken as the start time of the expected user.

The Exceptions table is also checked for any entries concerning the machine or location which are relevant for that day. An entry in the Exceptions table which is valid for that day and sets an end time, will override any user based end time. Such an entry could, for example, be made by an administrator to take account of there being a special early closure of the facility on that day.

If there are no appropriate entry in the Exceptions table which set an end time, the application queries the User_Machine_Location_Time table. If there is an appropriate entry linking the expected user with the machine, or at least the machine's location, and that has an end time, then that is taken as the end time.

If there is no entry in the User_Machine_Location_Time table, then the application looks at the Users table for the default start time for that user.

If for some reason there is no default end time in the Users table, for example because the user is new, then the application takes the default end time for the machine from the Machines table. If there is not default end time for that, then the application takes the default end time for the machine's location, from the Locations table. It is envisaged that there will always be default start and end times for a location, set up by an administrator.

Once an end time has been established, it is stored in the Machine_Next_Times table and the application will go through an appropriate routine at that time before turning the machine off.

That turn off routine will consist firstly of checking whether the user is still using the machine. If the user is working later than expected, the application checks the position at intervals, until there has been a predetermined period of inactivity on the machine. Once it can be assumed that the user has finished work, the application proceeds with some additional checks.

Firstly, the application looks at the Exceptions table to determine whether there have been any entries added in respect of the user, machine or location, that could extend the end time. If there is an entry, then that is used to change the end time.

Following that check, the procedure set out above for determining the expected user is carried out in respect of the remainder of the day after the end time for the current user, to see if there is going to be another user. If there is, then a start time for that user is established. If the period between the first user logging out and the second user being expected to start work is below a predetermined limit, then the machine is not switched off. Otherwise, the machine is switched off until the start time for the next user.

Of course, that next user could be the same person, for example if a person is set up as having a long break in the middle of the day, for example.

If a user logs out from the system at an unexpectedly early time, the application firstly waits for a period to see whether the user logs back in again. This can happen if a user needs to restart the operating system, deal with a wayward application and so forth. Once it can be assumed that the user has logged off for a significant period, the application goes through the above procedures of checking the Exceptions table and then for a second expected user. If there is a second expected user for that day and the time until that user's start is below a predetermined limit, then the machine is left on, otherwise it is switched off.

Once a workstation has been turned on, as noted above the system waits until a user logs in. If no user logs in within a predetermined time, that may be set by an administrator and could for example be an hour, the system assumes that the user will not be working on that day and goes through a switch off routine as described above. The event is recorded. The event can be recorded against the workstation and against the expected user of the workstation. If on a subsequent day—or the next day when the expected user is the same—there is again no use of the workstation, the system records the event again. The system then assumes that the user is absent on sick leave or on holiday and that the period of absence may continue. An entry is made in the Exceptions table to indicate that the workstation will not be used for a period, or that a particular user will not be working for a period. The period can be chosen in accordance with suitable rules. For example, the period my be until the end of the current working week.

Thus, for example, if a user does not work on a Monday and Tuesday, it may be assumed that the user will be away until the following Monday. The system will switch the workstation on again for that user on that Monday. If again the user does not work, the system may assume that the user is away for a two week holiday, and may not switch the workstation on again for that user until the following Monday. Alternatively, and indeed at any time when a period of absence has been noted, the system could send a message to an administrator, asking whether there is an exception that needs to be recorded. For example, it might be the case that a user will be away for an extended period on sick leave and the inclusion of that in the Exceptions table has been overlooked.

In general, any change is working pattern which goes beyond what might be expected in the normal operation of an organisation, and which is not dealt with by an exception, could prompt a message to an administrator.

As regards start time in general, it will be appreciated that in practice the application will adjust the actual start time to a suitable period before the start time determined from the stored data, to give the machine time to turn on, deal with any updates that may be necessary, and be ready for a user to log on. An administrator determined offset can be applied to the control application 300 using the administrator module 306, with this offset being variable if there is a change in software, routines carried out when a machine starts up, and so forth.

In a preferred implementation of the system, day to day variations in working pattern are handled, and the analysis application further creates entries for a User_Day table and a Machine_Day table.

User_Day

User ID
Day Number
Start Time
End Time

Machine_Day

Machine ID
Day Number
Start Time
End Time

For these two tables, the Day Number will be in the range 1 to 7, representing the days Monday to Sunday.

The User_Machine_Location_Time table is modified to include an additional filed for the Day Number

User_Machine_Location_Time

User ID
Machine ID
Location ID
Start Time
End Time
Day Number

Entries are only made in these three tables if there is a regular alteration in working pattern for a particular day or days, or if the working pattern is different for each day. When looking at the User_Machine_Location_Time table in the determination of a start time or end time, if there is an entry which is for a day number corresponding to the current day number, then that will take precedence over an entry with no day number specified. Similarly, before looking at the Users or Machines table for a default start time or end time, the application will look for any entries in the User_Day table or Machine_Day table for the user or machine concerned, in respect of the current day.

There is thus provided a versatile and configurable system for switching machines off at a time determined in accordance with the historical working patterns for a user and/or a particular machine, and for switching the machines on again at an appropriate time based on historical working patterns for the machine and/or for a predicted user of the machine.

It will be appreciated that features of a number of embodiments may be of use independently of the first aspect of the invention referred to initially. Accordingly, for example, the following combinations of features may also be expressed as independent inventions.

Thus, one invention disclosed herein provides a power control system for a plurality of data processing workstations which are connected to a network, in which an application running on a server connected to the network is configured to send instructions to the workstations to cause the workstations to enter a low energy usage state at a time assumed to be after the end of a working day for the workstations, characterised in that the application has access to a profile database which stores records of data representative of the identity of a user logged in, the identity of the workstation on which that user is logged in, and the time or assumed time at which the user ceases work on the workstation at the end of a working day, the stored data being used to create a profile for a user indicating an expected end of the working day for that user and/or a profile for a workstation indicating an expected end of the working day for that workstation.

Another invention provides a power control method for a plurality of data processing workstations which are connected to a network, in which an application running on a server connected to the network is configured to send instructions to the workstations to cause the workstations to enter a relatively low energy usage state from a relatively high energy usage state at a time assumed to be after the end of a working day for the workstations, characterised in that the application has access to a profile database which stores for each particular workstation, data representative of an estimated working day end time for that workstation, and the application sends an instruction to each workstation to cause the workstation to enter the relatively low energy usage state at the estimated working day end time for that particular workstation.

This invention also provides data processing apparatus connected to a network on which there is a plurality of data processing workstations, the apparatus including a server which is configured to run an application which sends instructions to the workstations to cause the workstations to enter a relatively low energy usage state from a relatively high energy usage state at a time assumed to be after the end of a working day for the workstations, characterised in that the application has access to a profile database which stores for each particular workstation, data representative of an estimated working day end time for that workstation, and the application sends an instruction to each workstation to cause the workstation to enter the relatively low energy usage state at the estimated working day end time for that particular workstation.

This invention also extends to a data processing system comprising such data processing apparatus and a plurality of the workstations, connected by a network.

This invention also extends to a computer program product containing instructions which, when executed on data processing apparatus will cause the apparatus to be configured as set out above.

Another invention provides a power control method for a plurality of data processing systems which are connected to a network, in which an application running on a server connected to the network is configured to send instructions to the workstations to cause the workstations to enter a relatively low energy usage state from a relatively high energy usage state a time assumed to be after the end of a working day for the workstations, characterised in that the application has access to a profile database which stores for of a plurality of workstation users, data representative of an estimated working day end time for that workstation user, and the application sends an instruction to each workstation to cause the workstation to enter the relatively low energy usage state at the estimated working day end time for the user of that particular workstation.

This invention also provides data processing apparatus connected to a network on which there is a plurality of data processing workstations, the apparatus comprising a server which is configured to run an application which sends instructions to the workstations to cause the workstations to enter a relatively low energy usage state from a relatively high energy usage state at a time assumed to be after the end of a working day for the workstations, characterised in that the application has access to a profile database which stores for of a plurality of workstation users, data representative of an estimated working day end time for that workstation user, and the application sends an instruction to each workstation to cause the workstation to enter the relatively low energy usage state at the estimated working day end time for the user of that particular workstation.

This invention also extends to a data processing system comprising such apparatus and a plurality of the workstations, connected by a network.

This invention also extends to a computer program product containing instructions which, when executed on data processing apparatus will cause the apparatus to be configured as set out above.

Another invention provides a power control method for a plurality of data processing workstations which are connected to a network, in which an application running on a server connected to the network is configured to send instructions to the workstations to cause the workstations to enter a low energy usage state at a time assumed to be after the end of a working day for the workstations, characterised in that the application has access to a profile database which stores records of data representative of the identity of a user logged in, the identity of the workstation on which that user is logged in, and the time or assumed time at which the user ceases work on the workstation at the end of a working day, the stored data being used to create a profile for a user indicating an expected end of the working day for that user and/or a profile for a workstation indicating an expected end of the working day for that workstation.

Another invention provides a power control method for a plurality of data processing workstations which are connected to a network, in which an application running on a server connected to the network is configured to send instructions to the workstations to cause the workstations to change from a low energy usage state to a higher energy usage state at a time assumed to be at the start of a working day for the workstations, in which the application has access to a profile database which stores for each particular workstation, data representative of an estimated working day start time for that workstation, and the application sends an instruction to each workstation to cause the workstation to enter the higher energy usage state at the working day start time for that particular workstation.

This invention also extends to data processing apparatus connected to a network on which there is a plurality of data processing workstations, the apparatus comprising a server which is configured to run an application which sends instructions to the workstations to cause the workstations to change from a low energy usage state to a higher energy usage state at a time assumed to be at the start of a working day for the workstations, in which the application has access to a profile database which stores for each particular workstation, data representative of an estimated working day start time for that workstation, and the application sends an instruction to each workstation to cause the workstation to enter the higher energy usage state at the working day start time for that particular workstation.

This invention also provides a data processing system comprising such apparatus and a plurality of the workstations, connected by a network.

This invention also provides a computer program product containing instructions which, when executed on data processing apparatus will cause the apparatus to be configured as set out above.

Another invention provides a power control system for a plurality of data processing systems which are connected to a network, in which an application running on a server connected to the network is configured to send instructions to the workstations to cause the workstations to enter a higher energy usage state from a low energy usage state at a time assumed to be the start of a working day for the workstations, characterised in that the application has access to a profile database which stores for each of a plurality of workstation users, data representative of an estimated working day end time for that workstation user, and which stores for each of the plurality of workstations data representative of the user most likely to be using that workstation, and the application sends an instruction to each workstation to cause the workstation to enter a higher energy usage state at the estimated working day start time for the user most likely to be using that particular workstation.

In a preferred arrangement, the system can deal with both workstation and user profiles to determine expected working day start time and expected working day end times.

Another invention provides a power control system for a plurality of data processing systems which are connected to a network, in which an application running on a server connected to the network is configured to send instructions to the workstations to cause the workstations to enter a higher energy usage state from a low energy usage state at a time assumed to be the start of a working day for the workstations, and to send instructions to the workstations to cause the workstations to enter a higher energy usage state from a low energy usage state at a time assumed to be the end of a working day for the workstations, characterised in that the application has access to a profile database which stores for each of a plurality of workstation users, data representative of an estimated working day start time and an estimated working day end time for that workstation user, and which stores for each of the plurality of workstations data representative of the user most likely to be using that workstation; the application sends an instruction to a particular workstation to cause the workstation to enter a higher energy usage state at the estimated working day start time for the user most likely to be using that particular workstation; and when a user has logged in to the particular workstation the application sends an instruction to the workstation to cause the workstation to enter a lower energy usage state at the estimated working day end time for the user.

Another invention provides a power control system for a plurality of data processing systems which are connected to a network, in which an application running on a server connected to the network is configured to send instructions to the workstations to cause the workstations to enter a higher energy usage state from a low energy usage state at a time assumed to be the start of a working day for the workstations, and to send instructions to the workstations to cause the workstations to enter a higher energy usage state from a low energy usage state at a time assumed to be the end of a working day for the workstations, characterised in that the application has access to a profile database which stores for each of the plurality of workstations data representative of an estimated working day start for that workstation, and which stores for each of a plurality of workstation users, data representative of an estimated working day end time for that workstation user; the application sends an instruction to a particular workstation to cause the workstation to enter a higher energy usage state at the estimated working day start time for the workstation; and when a user has logged in to the particular workstation the application sends an instruction to the workstation to cause the workstation to enter a lower energy usage state at the estimated working day end time for the user.

Another invention provides a power control system for a plurality of data processing workstations which are connected to a network, in which an application running on a server connected to the network is configured to send instructions to the workstations to cause the workstations to enter a relatively high energy usage state at a time assumed to be the start of a working day, and to enter a relatively low energy usage state at a time assumed to be the end of a working day, characterised in that the application has access to at least one profile database which stores records of data representative of the identity of a user logged in, the identity of the workstation on which that user is logged in, the time at which the user logged in to the workstation, and the time or assumed time at which the user ceases work on the workstation at the end of a working day, the records of data being used to provide in respect of a particular workstation, data indicating the user most likely to use that workstation, and/or an estimated working day start for that workstation and/or an estimated working day end for that workstation; the records of data further being used to provide in respect of a particular user, data indicating an estimated working day start for that user and/or an estimated working day end for that user; whereby:

the time assumed to be the working day start for a workstation is either the estimated working day start for that workstation, or the estimated working day start for the user most likely to use that workstation; and

the time assumed to be the working day end for a workstation is either the estimated working day end for that workstation, or the estimated working day end for a user on that workstation.

In some embodiments of inventions disclosed herein, if a working pattern for a workstation and/or a user differs significantly from the working pattern represented by data stored in the database, an incremental change to the working pattern for that workstation and/or user is implemented over a period of time.

In some embodiments, the invention provides a power control system for workstations which are connected to a network. An application running on a server has access to a profile database which stores workstation and user profiles of estimated workstation start and end times and estimated user start and end times, and sends shut down and start up instructions to each workstation in accordance with the profile data. The time assumed to be the working day start for a workstation is either the estimated working day start for that workstation, or the estimated working day start for the user most likely to use that workstation. The time assumed to be the working day end for a workstation is either the estimated working day end for that workstation, or the estimated working day end for a user on that workstation. Workstation and user data is logged to create the profiles.

In general, inventions encompassed by this disclosure extend to all combinations of the various methods discussed of estimating a start time and/or end time for a workstation, in which at least one of the start time and/or end time is determined by reference to a profile for the workstation and/or a profile for an actual user of the workstation or for a predicted user of the workstation. Whilst at least one of the start time and/or end time is so determined, the other could be pre-determined, for example by reference to a default start time and/or a default end time.

1. A power control method for a plurality of data processing workstations which are connected to a network, in which an application running on a server connected to the network is configured to send power down instructions to the workstations to cause the workstations to enter a relatively low energy usage state from a relatively high energy usage state at a time assumed to be after the end of a working day for the workstations, wherein the application has access to a profile database which stores for each particular workstation and/or for each user of a workstation, data representative of an estimated working day end time for that workstation or user, and the application sends a power down instruction to each workstation to cause the workstation to enter the relatively low energy usage state at the estimated working day end time for that particular workstation or user, and wherein the estimated working day end time is determined by an analysis application which analyses stored data representative of logging out times over a period.

2. A method as claimed in claim 1, wherein the profile database stores a estimated working day end time for both users and workstations; and in respect of a particular workstation being used by a particular user, if there is stored data representative of an estimated working day end time for that user, that working day end time is used for sending the power down instruction to the workstation, and if there is no stored data representative of an estimated working day end time for that user, stored data representative of an estimated working day end time for that workstation is used as the working day end time for sending the power down instruction to the workstation.

3. A method as claimed in claim 1, wherein the profile database stores for each particular workstation data representative of an estimated working day start time for that workstation, and the application sends a power up instruction to a workstation to cause the workstation to enter the higher energy usage state at the working day start time for that particular workstation, and wherein the estimated working day start time is determined by an analysis application which analyses stored data concerning logging out times over a period.

4. A method as claimed in claim 1, wherein the profile database stores, for each particular workstation, data representative of an expected user of the workstation, and also stores data representative and of an estimated working day start time for users, and the application sends the power up instruction to a workstation to cause the workstation to enter the higher energy usage state at the estimated working day start time for the expected user of that particular workstation.

5. A method as claimed in claim 4, wherein the profile database stores, for each particular workstation, data representative of an estimated working day start time for that workstation; and in respect of a particular workstation and a particular expected user of that workstation, if there is stored data representative of an estimated working day start time for that expected user, that working day start time is used for sending the power up instruction to the workstation, and if there is no stored data representative of an estimated working day start time for that expected user, stored data representative of an estimated working day start time for that workstation is used as the working day start time for sending the power up instruction to the workstation.

6. A method as claimed in claim 4, wherein the profile database stores data representative of expected users for workstations, which are dependent on the day of the week.

7. A method as claimed in claim 3, wherein the profile database stores data representative of estimated working day start times which are dependent on the day of the week.

8. A method as claimed in claim 1, wherein the profile database stores data representative of estimated working day end times which are dependent on the day of the week.

9. A method as claimed in claim 1, wherein the profile database stores data representative of exceptions from working patterns for workstations and/or users.

10. A method as claimed in claim 1, wherein the profile database stores data which is location dependent.

11. (canceled)

12. Data processing apparatus configured to send power down instructions to a plurality of workstations to cause the workstations to enter a relatively low energy usage state from a relatively high energy usage state, the apparatus being connected to a network so as to be able to communicate with the plurality of data processing workstations and comprising a server which is configured to run an application arranged to send instructions to the workstations to cause the workstations to enter a the relatively low energy usage state from the relatively high energy usage state at a time assumed to be after the end of a working day for the workstations; wherein the application has access to a profile database which stores for each particular workstation and/or for each user of a workstation, data representative of an estimated working day end time for that workstation or user, and the application is arranged to send a power down instruction to each workstation to cause the workstation to enter the relatively low energy usage state at the estimated working day end time for that particular workstation or user, and wherein the estimated working day end time is determined byan analysis application which analyses stored data representative of logging out times over a period.

13. Data processing apparatus as claimed in claim 12, being further configured so that the profile database stores for each particular workstation data representative of an estimated working day start time for that workstation, and the application sends a power up instruction to a workstation to cause the workstation to enter the higher energy usage state at the working day start time for that particular workstation, and wherein the estimated working day start time is determined by an analysis application which analyses stored data concerning logging out times over a period.

14. Data processing apparatus as claimed in claim 12, in combination with a plurality of workstations connected to the apparatus by means of the network.

15. A non-transitory computer program product comprising instructions stored on a physical medium which, when executed on data processing apparatus connected to a plurality of workstations, will cause the apparatus to be configured so as to send power down instructions to the plurality of workstations to cause the workstations to enter a relatively low energy usage state from a relatively high energy usage state under the control of an application, the instructions to the workstations to cause the workstations to enter a the relatively low energy usage state from a the relatively high energy usage state being sent at a time assumed to be after the end of a working day for the workstations; wherein the application has access to a profile database which stores for each particular workstation and/or for each user of a workstation, data representative of an estimated working day end time for that workstation or user, and the application is arranged to send a power down instruction to each workstation to cause the workstation to enter the relatively low energy usage state at the estimated working day end time for that particular workstation or user, and wherein the estimated working day end time is determined by an analysis application which analyses stored data representative of logging out times over a period.

16. A computer program product as claimed in claim 16, wherein the instructions, when executed on the data processing apparatus, are further such that the data processing apparatus will be configured so that the profile database stores for each particular workstation data representative of an estimated working day start time for that workstation, and so that the application sends a power up instruction to a workstation to cause the workstation to enter the higher energy usage state at the working day start time for that particular workstation, and wherein the estimated working day start time is determined by an analysis application which analyses stored data concerning logging out times over a period.

17. Data processing apparatus as claimed in claim 13, in combination with a plurality of workstations connected to the apparatus by means of the network.
